(19) United States
(12) Patent Application Publication
(10) Pub. No.: US 2013/0117006 A1
(43) Pub. Date: May 9, 2013

(54) SIMULATED BOOT PROCESS TO DETECT INTRODUCTION OF UNAUTHORIZED INFORMATION

(71) Applicants: Asish George Varghese, Redmond, WA (US); Chih-Pin Kao, Redmond, WA (US); Robert Fanfant, Clyde Hill, WA (US); Hakki Tunc Bostanci, Redmond, WA (US)

(72) Inventors: Asish George Varghese, Redmond, WA (US); Chih-Pin Kao, Redmond, WA (US); Robert Fanfant, Clyde Hill, WA (US); Hakki Tunc Bostanci, Redmond, WA (US)

(73) Assignee: MICROSOFT CORPORATION, Redmond, WA (US)

(21) Appl. No.: 13/290,154

(22) Filed: Nov. 7, 2011

(51) Int. Cl. G06F 9/455

(52) U.S. Cl. 703/22

(57) ABSTRACT

Techniques involving a simulated start-up or “boot” process to detect the introduction of unauthorized code or data into the boot process. In one embodiment, a boot process is performed to initiate a computing system. The boot process is then simulated using the initiated computing system to detect unauthorized modifications introduced into the computing system prior to the computing system's operating system being operational.

### BACKGROUND

Computer security is a broad concept covering various types of unauthorized involvement with computing systems. A person who attempts to manipulate or alter a computing system, sometimes colloquially referred to as a “hacker,” often tries to bypass security measures to meet an objective. Unauthorized modifications, accesses or other involvement with computer programs or systems may be performed for malicious purposes, for profit, to avoid a legitimate cost, for challenge, or the like.

Unauthorized uses may come in the form of viruses, rootkits, attempts to bypass license/payment or other use requirements, etc. For example, individuals may attempt to avoid paying required license fees for programs and other software used on computing systems. Such programs may include, for example, operating systems, applications that run on the operating systems, etc. Original equipment manufacturer (OEM) versions of operating systems and/or other programs may use license verification techniques to determine whether a user invoking the program is authorized to use it. If a person can inject unauthorized code or otherwise modify the system, he/she may be able to evade required payment or other use requirements.

To complicate matters, such unauthorized modifications could, in some instances, be applied before the operating system of the computing system is active. In such cases, discovery of the unauthorized practice may be difficult or impossible to detect, as the unauthorized act occurred prior to operating of the system software. For example, licensing information provided with a basic input/output system (BIOS) or analogous firmware may enable an OEM machine to activate without negotiating activation with an external activation server. An activated OEM machine may, therefore, be seen as a genuine machine without further verification beyond the licensing information stored in the BIOS or related logic.

Such licensing information could, however, be obtained from a legitimate OEM machine, and installed on another non-OEM machine. In essence, such unauthorized activity enables the non-OEM machine to appear as a legitimately activated machine, thereby circumventing licensing requirements.

One solution to such unauthorized activities is to evaluate any known exploits to determine the digital information or “signature” that is injected in connection with the exploit. This signature can be stored with other obtained signatures in back end servers to be compared against incoming activation requests from client systems. Thus, a database of specific hackers' exploit signatures must be maintained, and compared when system or software activation is solicited. However, hackers can slightly modify the hackers exploit signatures to make the digital information differ from what may be stored, thereby avoiding recognition as an exploit. Such digital signatures may, in fact, be changed every time the exploit is installed on a client machine. Thus, given this current attack vector, signature-based detection is not feasible.

### SUMMARY

Techniques involving a simulated boot process to detect the introduction of unauthorized code or data into the boot process. One representative technique includes a computer-implemented method where a system start-up process is performed to initiate a computing system. The system start-up process is simulated using the initiated computing system to detect unauthorized modifications introduced into the computing system prior to the computing system's operating system being operational.

Another representative implementation involves an apparatus that includes storage to store instructions used to initialize a computing system and its operating system. A simulated boot engine is configured to detect activation exploits introduced on the computing system prior to the operating system being loaded. In one embodiment, the simulated boot engine includes an execution module configured to simulate execution of the stored instructions, and a pattern detector module. In one embodiment, the pattern detector module is configured to compare licensing information resulting from the simulated execution of the instructions to expected licensing information based on a rule(s), and to detect the activation exploits based on a mismatch of the comparison.

In another representative embodiment, computer-readable media, on which instructions are stored, are executable by a processor to perform various functions, including booting a computing system that has an operating system. After the operating system is operational, the executable instructions enable simulation of the previous booting of the computing system in a sandbox environment that is isolated from normal operations of the computing system. In one embodiment, the simulation of the computing system booting includes reading instructions from a boot sector(s) of boot media, executing the instructions, monitoring a software licensing (SLIC) description table for illicitly-introduced code or data, and if the monitoring of the SLIC table identifies the presence of the illicitly-introduced data, designating the operating system as an unauthorized operating system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram depicting a representative technique for detecting unauthorized exploits or other activity prior to execution of an operating system;

FIG. 2 is a flow diagram illustrating a representative technique for detecting unauthorized changes in a boot process of a computing system;

FIGS. 3A and 3B are block diagrams generally depicting an example for detecting activation exploits attempting to circumvent software licensing requirements;

FIG. 4 is a block diagram of a representative simulated boot engine in accordance with the techniques described herein;

FIG. 5 is a flow diagram generally corresponding to functions of the simulated boot engine of FIG. 4;

FIG. 6 is a flow diagram illustrating an exemplary technique for generally detecting the introduction of unauthorized code and/or data into a boot sequence before an operating system is operational;

FIG. 7 is a flow diagram illustrating an exemplary manner for detecting and acting on activation exploits; and

FIG. 8 depicts a representative computing apparatus or device in which the principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to detecting unauthorized exploits impacting computing systems and/or devices incorporating computing systems. As used herein, an exploit generally refers to software, data, sequences of commands and/or other digital information that exploits some known or unknown vulnerability in a computing system. Such exploits can come in a variety of forms, such as activation exploits to bypass licensing requirements, viruses, rootkits and other malicious software (malware), etc. While there are numerous manners of detecting such exploits using operating systems or programs/applications executing on top of the operating system, exploits introduced before execution of the operating system are difficult to identify. Among other things, the disclosure sets forth techniques to identify exploits or “hacks” impacting computing systems, including those introduced during start-up procedures where the operating system is not yet operative.

Where an operating system has not yet been fully initiated, the computer system may be referred to as being in a start-up state, a stage often referred to as bootstrapping or “booting” the computing system. This stage may be initiated by initiating first code upon power up of the computing system. One example involves the basic input/output system (BIOS) that serves as a firmware interface. While other analogous firmware interfaces may be used, and the techniques described herein are equally applicable to any such interfaces, many of the examples described herein are expressed in terms of BIOS, extensible firmware interface (EFI) or Unified EFI (UEFI) interfaces.

In general, bootstrapping firmware in the BIOS or other interface hardware/firmware will perform various self tests, and load and execute a master boot record (MBR) which may be on the first sector of a boot disk (e.g. hard disk or other target boot disk). The MBR or equivalent may include a master partition table for partitions on storage, and master boot code that the BIOS can load into memory (or elsewhere). Execution of the master boot code starts the boot process, which may include a program that copies additional code (e.g. boot loader) from storage into memory. Control may then be passed to the boot loader, which is responsible for loading the operating system.

As can be seen from this exemplary booting process, significant activity occurs before the operating system (OS) or other supervisory code (e.g. including hypervisors, etc.) is even loaded and operative. During this “pre-OS” stage, code is stored, moved, executed, and otherwise processed to carry out functions to effect a proper initiation of the computing apparatus. Since the OS and other applications are not yet operative, this may prove to be a vulnerable time for the computing device, as no monitoring is taking place for injection of malicious or unauthorized code or data. For example, a user could attempt to illicitly change the code and/or data in the storage/memory involved in the pre-OS booting stage. This activity may cause unauthorized changes to code, data, power systems, video, drives or other code/data by the master boot record, boot sector, or other code/data implicated before the boot process reaches an operative kernel.

One particular example involves software activation exploits. In the case of operating systems or other supervisory software that is loaded during the start-up or boot phase, a user may install code on the computing system in an effort to bypass activation of the operating system itself, thereby eluding licensing requirements. Such efforts can enable the operating system to load as a genuine operating system, where in fact it is an unlicensed copy made to appear genuine by way of the activation exploit. Where the activation exploits are loaded before the operating system is loaded, such early activation exploits can be difficult or impossible to detect.

In an activation exploit or other unauthorized action, the hacker's code can be run through, for example, the boot sector, master boot record, etc. In one example, when a machine boots, the BIOS or equivalent technology takes control. It reads the first sector of the hard disk, which reads the partitions in the hard drive. At the beginning of each partition is a boot sector that reads the boot loader, which in turn reads the rest of the OS, which starts to load. In one particular activation exploit, the unauthorized code/data is inserted into some point in this boot chain, whether it be the boot sector, first sector of the boot disk, etc. In one case, the aim is to change a certain table related to the BIOS that involves licensing information—namely, the software licensing description (SLIC) table.

The SLIC table represents a digital signature made available in the BIOS or equivalent structure in machines having OEM versions of operating systems. The SLIC may be provided in the advanced configuration and power interface (ACPI) or elsewhere. To activate an OEM OS, the OS itself looks at various items when it is operative, such as a license, product key, SLIC table, etc. If a person changes the SLIC table that is in the memory prior to the OS loading, the subsequently operative OS may see that the SLIC table has the appropriate OEM licensing information, thereby making the OS appear to be an authorized version. As seen in this example, by the time the OS has booted up, it is too late as the activation exploit has already occurred.

The techniques described herein enable such pre-OS exploits to be detected, and if desired, action may be taken in response thereto. Among other things, techniques described in the disclosure enable a computing system to be booted up, where a simulated boot up process is then employed using the initiated computing system to detect unauthorized modifications introduced into the computing system prior to the computing system's operating system being operational.

Various embodiments below are described in terms of BIOS (basic input/output system) as representative terminology for a firmware interface standard and/or software/firmware that loads an operating system. However, the principles described herein are equally applicable to other such interface standards and/or software/firmware that loads an operating system, such as the extensible firmware interface (EFI), unified extensible firmware interface (UEFI), etc. Reference to BIOS, EFI, UEFI and/or other particular standard and/or firmware interface is intended to be applicable to all such standards and/or firmware interfaces, unless otherwise noted. Thus, unless otherwise noted, reference to any particular standard and/or firmware interface is not intended to exclude applicability of other such standards and/or firmware interfaces. As a particular example, many descriptions herein are generically described in terms of “BIOS,” yet such descriptions should not be interpreted as, nor are they intended to be, limited only to BIOS implementations. It should also be recognized that reference to an “operating system” may include any type of supervisory software that may control system functions and/or on which other applications may be executed, including the operating system running the system, guest operating systems provided in sandbox or other virtual environment, hypervisors, etc.

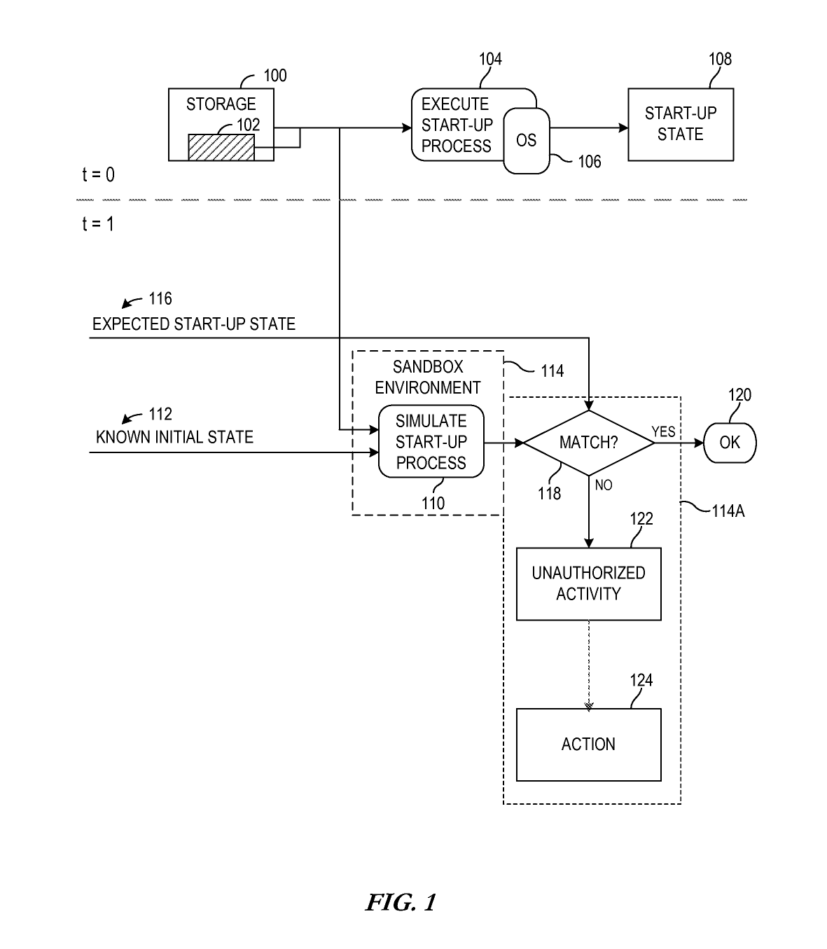

FIG. 1 is a block diagram depicting a representative technique for detecting unauthorized exploits or other activity prior to execution of an operating system. In the illustrated embodiment, the storage 100 can represent any boot storage, memory or other storage implicated in a start-up (e.g. boot) procedure. The storage 100 is depicted as having unauthorized code/data 102 or data that has been illicitly inserted by a user. A start-up (e.g. boot) process is executed as shown at block 104, which ultimately initiates the operating system (OS) 106. The start-up state 108 represents a condition(s) of the computing system in view of the unauthorized code/data 102 having been injected. For example, in the context of an activation exploit, the start-up state 108 may indicate a genuine machine with a validly activated OS where the unauthorized code/data 102 duped the system into believing that it is a properly activated OS. Thus, the start-up state 108 resulting from a start-up process 104 that has not been tainted by unauthorized code/data 102 will differ from a start-up process 104 that has been so tainted.

The start-up process 104 is assumed to have occurred at a first time, depicted at t=0. At this time, the start-up state 108 represents a condition that is at least partially a result of the unauthorized code/data 102 having been injected into the pre-OS start-up process 104. As previously noted, the OS 106 does not detect the unauthorized code/data 102 or its involvement in the start-up process 104, as the OS 106 was not executing at the time of the unauthorized activity. In accordance with one embodiment depicted in FIG. 1, a technique for detecting such pre-OS unauthorized activity is provided.

At least part of a start-up or boot process is simulated, which may occur after the initial booting of the OS 106. This is depicted at the subsequent time t=1. In one embodiment, the simulated start-up process 110 (also referred to herein as the simulated boot process) detects unexpected changes occurring prior to execution of the OS, or at least prior to execution of a part of the OS such as the kernel. A reference or known initial state 112 may be used as the basis for the simulated start-up process 110. The known initial state 112 may include any one or more of, for example, a simulated BIOS image, code/data associated with the master boot record or boot sectors, code/data in storage and/or memory, system or hardware interrupts, etc. The known initial state 112 represents a known condition of the code, storage and/or memory when the simulated start-up process 110 is to be invoked.

In one embodiment, the simulated start-up process 110 is executed in a sandbox environment 114 or other environment for separating running programs or processes. One example of a separate sandbox environment 114 is a virtual machine where an OS may be booted and run. By using a simulated BIOS image and/or the code and data stored for use during the boot process, the simulated start-up process 110 can be executed in the sandbox environment 114 to simulate the actual start-up process 104 of the computing system.

In one embodiment, an expected start-up state 116 is compared at block 118 to a resulting state of the simulated start-up process 110. For example, a resulting state of the simulated start-up process 110 may be a state of the boot process just prior to the OS loading, although any state during or after the start-up process 110 may be used as the reference point depending on what conditions are being tested. In one embodiment, the comparison at block 118 of the expected start-up state 116 and the resulting state of the simulated start-up process 110 is also determined in the sandbox environment as depicted by dashed block 114A. If the resulting state of the simulated start-up process 110 matches the expected start-up state 116, this establishes that no code, data or other information was illegitimately injected into the boot process as depicted at block 120. On the other hand, if the resulting state of the simulated start-up process 110 does not match the expected start-up state 116, this reveals that code and/or data was illicitly introduced during the boot process. This is depicted at block 122 that indicates that unauthorized activity has been detected. In response, some action(s) 124 may optionally be taken as described in greater detail below.

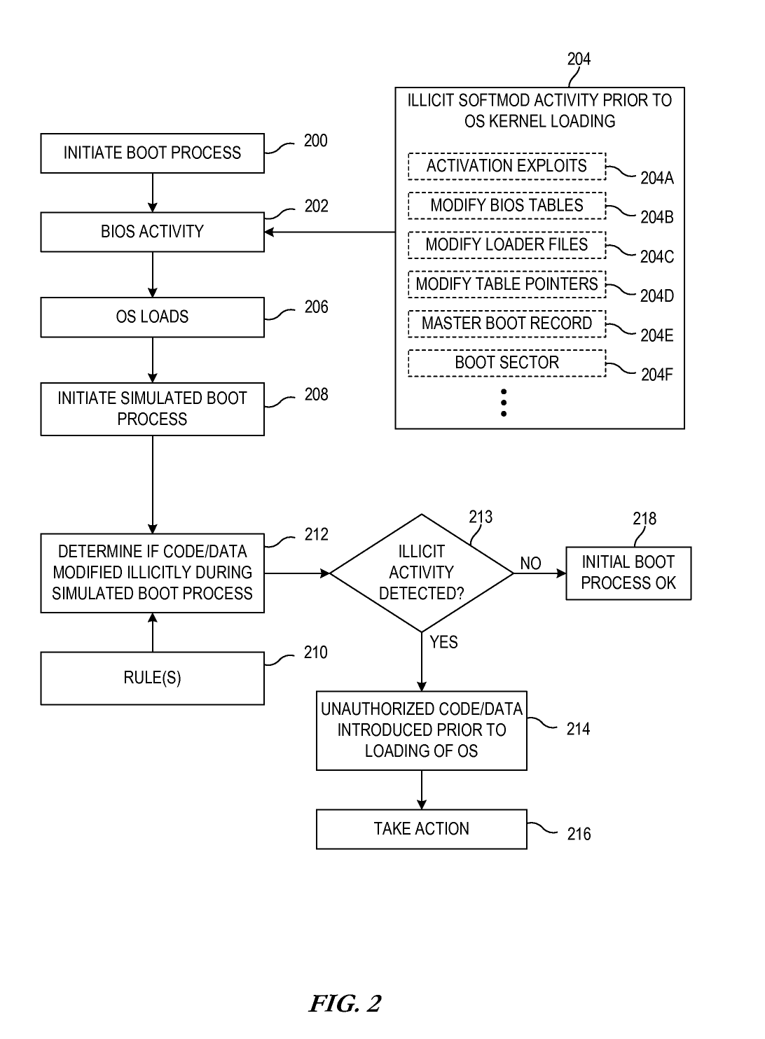

FIG. 2 is a flow diagram illustrating a representative technique for detecting unauthorized changes in a boot process of a computing system. In the illustrated embodiment, a boot process is initiated as depicted at block 200. At block 202, BIOS activity or other firmware interface activity occurs. In some cases, unauthorized code and/or data may be introduced into the BIOS activity 202. For example, block 204 represents examples of illicit softmod activity that may be introduced prior to the OS kernel loading. Examples include activation exploits 204A, modification of BIOS tables 204B, modification of loader files 204C, modification of table pointers 204D, changes to the master boot record 204E or boot sector 204F, etc. Under normal circumstances, the OS can ultimately load with the illicit softmod 204 having already impacted the computing system. For example, in the case of an activation exploit, the OS may be perceived as a genuine, licensed product even though it is not authorized, and only appears genuine through the unauthorized changes during the boot process. In such cases, the OS or system in general may be entirely unaware that any unauthorized activity has occurred.

In accordance with the disclosure, a simulated boot process may be initiated as depicted at block 208. Rules, as shown at block 210, may be used at block 212 where it is determined whether code and/or data has been illicitly modified during the simulated boot process. The rules may be dependent on the type of illicit activity being detected. For example, and as described in more specific examples below, detecting activation exploits may involve rules that monitor the presence of or changes to licensing data (e.g. SLIC table). In the case of detecting viruses, rootkits or other softmod activity prior to loading the OS, the rules may cause other comparisons or actions that the viruses, rootkits or other softmod activity could illicitly impact. For example, if a boot sector storage or memory location is initialized to a value, and it is known that such value should not change (or not change to certain values), the rules shown at block 210 can be used to make the appropriate determination at block 213. As a more particular example, if a binary value of “4” is indicative of a rootkit having been installed on a boot sector, the rules at block 210 can cause the determination at block 213 to compare the binary value of “4” to the result of the simulated boot process initiated at block 208. As these examples demonstrate, simulating the boot process may involve detecting unauthorized modifications to code and/or data by tracking changes occurring as a result of the boot process, and identifying deviations of the tracked changes to a predetermined rule(s).

If illicit activity is detected as determined at block 213, this suggests that the initial boot process at block 200 was indeed tainted as a result of some unauthorized code/data introduced prior to the kernel loading, as noted at block 214. If desired, action may be taken as shown at block 216, such as disabling the OS, providing a reduced-functionality OS, presenting warning messages, sending notification messages, or the like. If no illicit activity is detected at block 213, the initial boot process at block 200 can be viewed as a successful boot process with no illegitimate activity occurring, as shown at block 218.

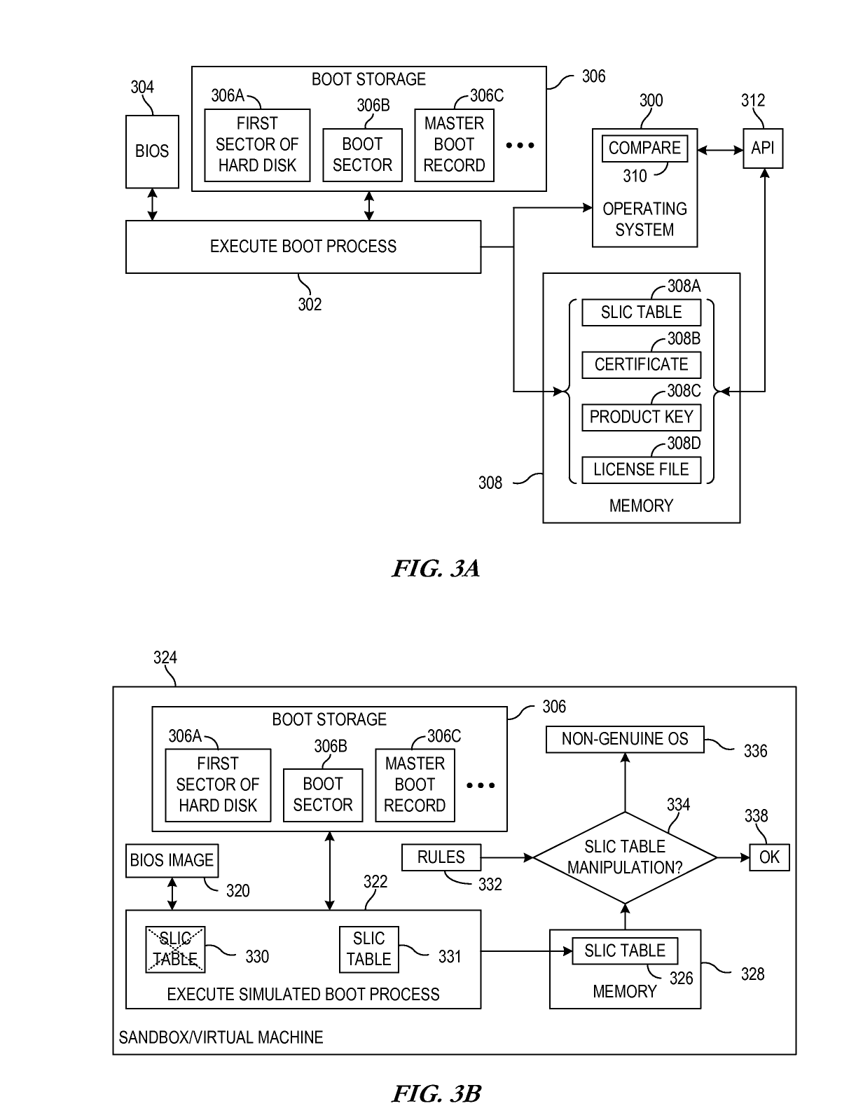

As noted above, one representative example of illicit activity occurring during a computing system boot process is an activation exploit. This may involve bypassing software activation requirements to verify licensing of the software product, such as licensing of an OEM operating system. FIGS. 3A and 3B are block diagrams generally depicting an example of how such an activation exploit may be detected. Like reference numbers are used for like items in the example of FIGS. 3A and 3B.

FIG. 3A depicts a representative manner in which a computing system may be booted or otherwise initiated to determine the authenticity of an operating system 300. In this example, a boot process may be executed at block 302 using, for example, BIOS 304, and boot storage 306 that may include any one or more of a first sector of a hard disk 306A or other boot disk, a boot sector 306B, master boot record 306C, etc. In one embodiment, the BIOS 304 information pulled into memory may be manipulated to make the OEM product appear to be properly licensed.

When the boot process is executed at block 302, any illicit changes to the BIOS 304 and/or boot storage 306 will be processed. When the operating system 300 is operative, it can perform functions to determine whether it is a valid OEM machine based on licensing data. For example, the licensing data may be stored in memory 308, and can include a SLIC table 308A or analogous data. Other licensing-related information may include any one or more of a digital certificate 308B, product key 308C, license file 308D, etc. For example, when a licensing service is invoked, it may look at the product key 308C that is installed to determine that it is an OEM product key. It may then look for a license file 308D that belongs to that OEM. For example, the license may indicate that the machine is from a certain computer manufacturer. The SLIC table 308A may be analyzed, or at least one or more markers in the SLIC table 308A. In accordance with the disclosure, any data indicative of valid licensing information may be considered, and those identified in FIG. 3A are depicted for purposes of example.

In one embodiment, when the OS 300 boots up, it can identify a valid OEM machine by comparing values in the memory 308 with reference or known values using a compare module 310. In one embodiment, the OS 300 makes one or more application programming interface (API) 312 calls to determine whether the values in the memory 308 correspond to what is expected to be found if it is a valid OEM machine. In a machine that has been tampered with by modifying information in the memory 308, such as the SLIC table 308A, the OS 300 may determine the machine is a valid OEM machine because the illicitly modified memory 308 indicates so.

In order to detect this condition, a simulated boot process as described herein may be utilized, as depicted in FIG. 3B. The BIOS, or a copy thereof as depicted by the BIOS image 320, and/or boot storage 306 may be the inputs to a simulated boot process shown at block 322. The execution of the simulated boot process may be executed via a virtual machine or other sandbox environment 324. Some portions, such as the boot storage 306, may or may not be implemented as part of the sandbox environment 324. For example, portions of the boot storage 306 (e.g. master boot record 306C) may be obtained directly from the boot storage for the execution of the simulated boot process at block 322, or that digital information may be stored elsewhere such as in the memory 328.

In the present example where the possible presence of activation exploits are being detected, the SLIC table 326 that may be stored in memory 328 can be used in the detection. More particularly, SLIC data (or analogous information) may be used to provide licensing information for certain computing systems utilizing an operating system or other software. In one embodiment, this licensing information is provided via a SLIC table 326, although this does not suggest that the licensing information need be in a “table” data structure. Such licensing information may be provided for OEM machines, so that device manufacturers can provide an operating system and/or other software that is licensed for use on that machine. In one embodiment, information or “markers” in a SLIC table 326 provided via an ACPI table or otherwise indicate whether an OEM machine is licensed to run the operating system. If the SLIC table 308A of FIG. 3A is tampered with so that it appears the operating system 300 is properly activated for the host device, then the SLIC table 326 resulting from the simulated boot process 322 will reflect a valid, activated operating system.

Therefore, if the BIOS image 320 and/or other information in the boot storage 306 is initially set to produce a reference or known state of the SLIC table 326, and the SLIC table 326 does not correspond to the known state of the SLIC table 326, the OS 300 can be determined to be illicitly tampered with, to avert licensing requirements. In one particular embodiment, the simulated boot process 322 is set up to generate no SLIC table at all, as depicted by block 330. If a SLIC table 326 is ultimately generated in the memory 328 as a result of the simulated boot process 322, it can be determined that code was introduced during the simulated boot process 322, since the simulated boot process 322 was configured to have no SLIC table. In this example, the rules 332 can be established to look for the existence of a SLIC table 326 in memory. If the SLIC table 326 is generated and found in the memory 328, it can be determined at block 334 that there has been manipulation of the SLIC table to bypass activation requirements. In such case the operating system can be designated as non-genuine as noted at block 336; otherwise the OS may be deemed genuine as noted at block 338.

It should be noted that the simulated boot process 322 can alternatively be configured to legitimately generate a SLIC table 326 in memory 328, in which case the rules 332 may be configured to detect whether the expected resulting state of the SLIC table 326 corresponds to the actual state of the SLIC table 326 following the simulated boot process 322.

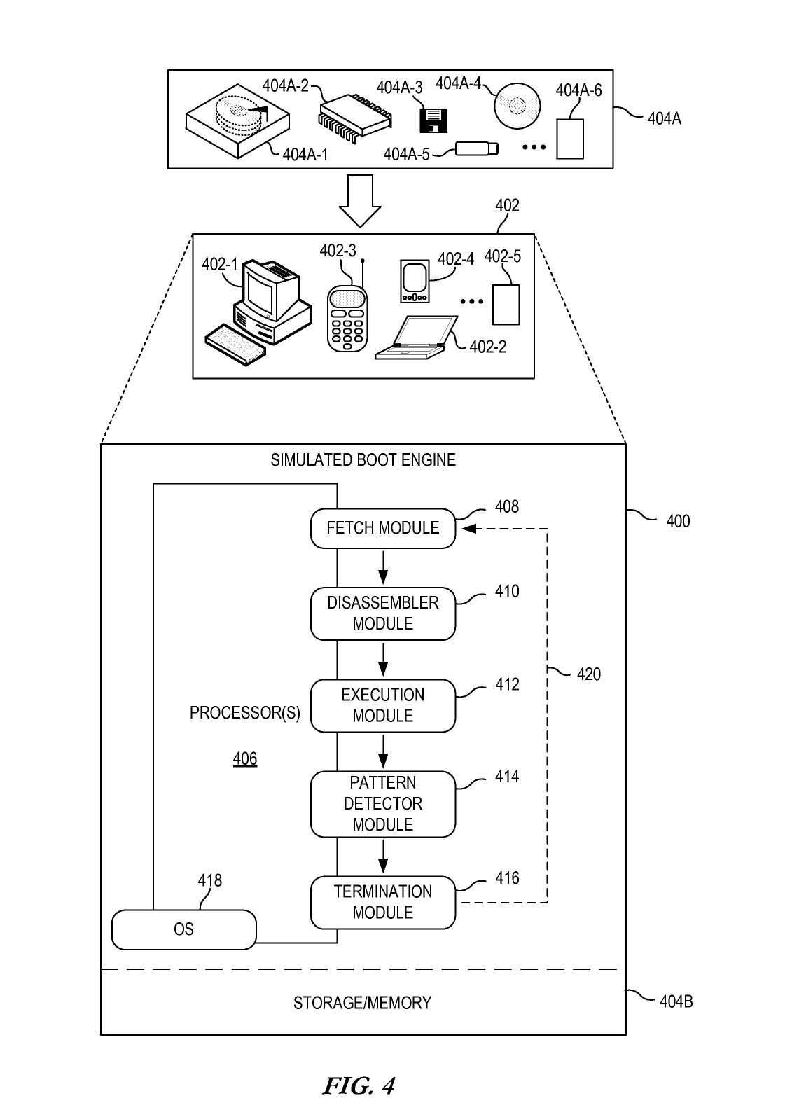

FIG. 4 is a block diagram of a representative simulated boot engine 400 in accordance with the techniques described herein. FIG. 4 depicts a number of representative apparatuses 402 in which the simulated boot machine 400 may be implemented. The apparatuses 402 depicted in FIG. 4 are for purposes of illustration, and does not represent an exhaustive list, as the techniques described herein are applicable to any device having a processing arrangement where firmware, software, data and/or other digital information may be utilized and potentially tampered with. Thus, the devices may be stand-alone computing devices, portable computing and/or communication devices, devices embedded into other products such as appliances or automobiles, etc. The representative apparatuses 402 of FIG. 4 include a desktop computer 402-1, portable computer (e.g. laptop) 402-2, mobile phone 402-3, personal digital assistant 402-4, or other 402-5 device capable of performing computing functions.

The apparatuses 402 may store program code/software, firmware, data and/or other digital information involved in the simulated boot processes described herein. Representative types of storage/memory 404 usable in such apparatuses 402 include, but are not limited to, hard disks 404A-1, solid state devices 404A-2, removable magnetic media 404A-3, fixed or removable optical media 404A-4, removable solid state devices 404A-5 (e.g. FLASH), or any other storage/memory device 404A-6. As an example, code and data may be permanently or temporarily stored on hard disks 404A-1 and memory on solid state devices 404A-2. Any such storage/memory 404A is also depicted as storage/memory 404B used in connection with the simulated boot engine 400.

The simulated boot engine 400 may be implemented in software, executable by a processor(s) 406. In the illustrated example, the representative simulated boot engine 400 includes various functional modules, including a fetch module 408, disassembler module 410, execution module 412, pattern detector module 414 and termination module 416. In this example, the simulated boot engine can verify the authenticity of the OS 418, although the techniques could be used to verify other programs, identify malware, etc. In the example of FIG. 4, an embodiment is described where the simulated boot engine 400 bootstraps the execution of the boot loader present in the master boot record of the boot media (e.g. hard disk 404A-1). The simulated boot engine 400 is loaded into a “sandbox” environment to isolate its execution with that of the OS 418.

Many activation exploits (e.g. softmod hacks) and rootkits replace the OS boot loader with a custom boot loader, giving them control over the system before the OS 418 boots. In such a case, the softmod class of hacks may modify the BIOS tables, loader files, table pointers, and/or the like to make the tainted OS 418 appear as a legitimate OEM machine. During the boot process, such class of hacks may complete the modification of the BIOS tables before the OS 418 loader starts. When this happens, the OS kernel, and consequently the licensing component, are unaware that they are using a tainted copy of the BIOS SLIC/ACPI tables. The representative simulated boot engine 400, and others described herein, detects these unique behavior patterns exhibited by such softmod hacks. The simulated boot process creates the simulated boot engine 400 which simulates the boot process and tricks the activation or other softmod exploit to display these unique behavior patterns.

In this example, the simulated boot engine 400 simulates each instruction in the master boot record down to the boot sector and boot loader. The fetch module 408 fetches these instructions, interprets the instructions in order to determine instruction length, and passes the instructions to the disassembler 410. The disassembler 410 translates the machine language to assembly language, thereby identifying information such as the operator(s) and operand(s). The execution module 412 simulates the execution of the instruction by modifying processor 406 registers, memory etc. The execution module 412 is configured to execute in various modes, such as, for example, 16-bit real mode, 16-bit, 32-bit or 64-bit protected mode, etc. The execution module 412 is also configured to handle interrupts. Real mode and protected mode memory addressing may also be handled by the execution module 412. Although instruction sets may be very large, not all instructions are typically used by boot loaders/exploits, and only a subset of such instructions are likely used by the exploits.

The pattern detector module 414 detects the patterns of interest. In case of an OS activation exploit, the pattern detector module 414 may be configured to check if the execution of any particular instruction caused a SLIC table to be inserted into the system storage/memory 404B. Such an embodiment catches the insertion of illegitimate licensing information in the form of a SLIC table where the simulated boot engine 400 is configured such that it would not involve a SLIC table. Other embodiments can assume the involvement of a SLIC table, but any resulting SLIC table can be compared to an expected resulting state to determine whether the SLIC table was changed during the boot process. If the check reveals the existence or modification of a SLIC table (depending on the embodiment employed), then an activation exploit or other softmod attack is present, and the OS 418 can be considered non-genuine.

In one embodiment, the pattern detector module 414 includes a compare functionality to compare expected and actual results. For example, the pattern detector module 414 may be configured to compare a SLIC table or licensing information resulting from the simulated instruction execution to expected SLIC or licensing information based on a rule(s), and to detect activation exploits based on a mismatch of such a comparison. In the current example, the rule(s) may be the presence of a SLIC table, the modification of a SLIC table, the mismatch of other licensing information from known, acceptable licensing data, etc.

The termination module 416 determines if the execution of the boot loader is complete, and whether the OS 418 has started to execute. If it has started to execute, then no exploit is present in the system, and the process can terminate. Otherwise control is passed to the instruction fetch module which fetches and processes the next instruction, as depicted by dashed line 420. The simulated boot process executes any detected exploit in a safe sandbox environment. In one embodiment, the simulated boot process is implemented as an OS 418 service, and can run once the OS 418 has booted up and thus is operational.

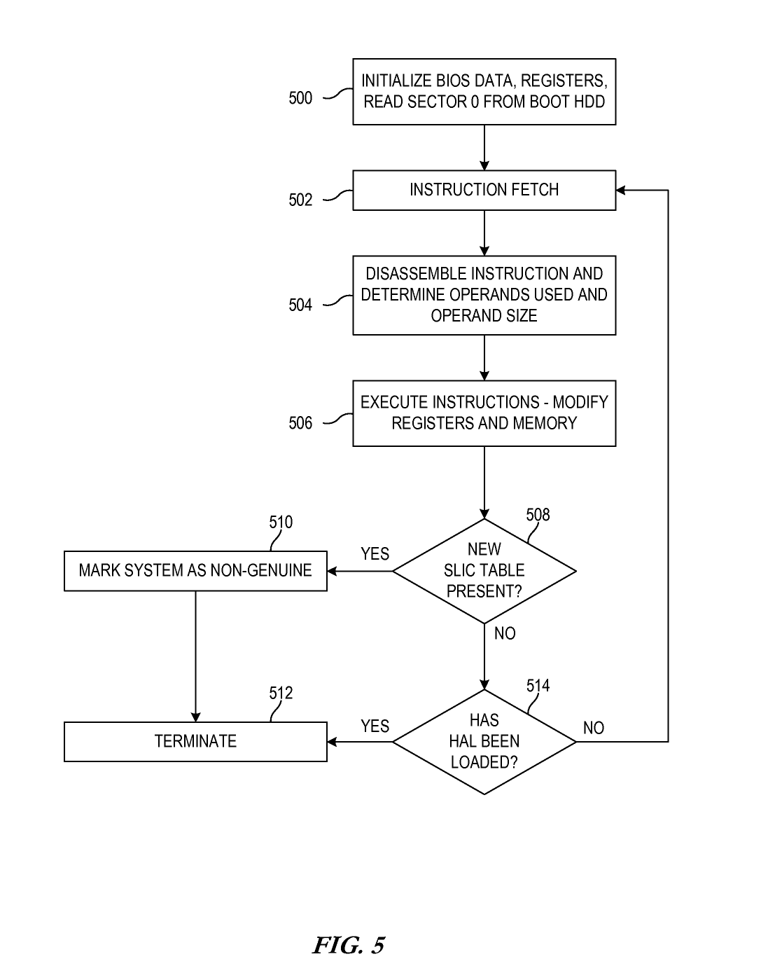

FIG. 5 is a flow diagram generally corresponding to the simulated boot process described in connection with FIG. 4. This embodiment is described in connection with FIG. 4. At block 500, BIOS data, registers, and read sector 0 is initialized from a boot disk. In one embodiment, block 500 involves taking generic or otherwise known BIOS data that does not have a SLIC table, and loading it into memory how the BIOS itself would load itself into memory. This simulated BIOS image is then used as the basis for the simulated boot process. As described below, if a SLIC table ultimately appears during the simulated boot process, it is known that it was injected during the boot process, and is therefore indicative of an activation exploit or other illicit activity involving the SLIC data. Other embodiments involve analogous determinations, where data other than SLIC table information is monitored to identify other exploits, softmod hacks, viruses, rootkits, etc.

As noted at block 500, after the simulated BIOS image has been initialized, the first sector from the boot drive may be read, which loads the master boot record in one embodiment. The fetch module 408 performs an instruction fetch as shown at block 502, and the disassembler module 410 can disassemble the instructions as shown at block 504 to identify information such as operators, operands used, operand size, etc. The execution module 412 executes the instructions as shown at block 506, to modify registers, memory, and/or other storage that is affected by execution of the instruction. In one embodiment, this essentially mimics a register table similar to what the processor 406 register table would be. As every instruction can be simulated, the simulated register, memory, etc. can be written to or otherwise modified to know the state of the processor 406 and/or memory, storage, etc. in this simulated machine environment. For example, memory locations may be set aside to store a simulated image of registers, memory, etc. Interrupts are handled analogously. Thus, as part of going through the instruction set, modifications are made to simulated registers, memory, interrupts and/or other handlers similar to what the actual system would do, except that it is performed on a virtual machine or in some other sandbox environment.

In one embodiment, the materialization of a SLIC table in response to any of the instruction operations indicates that the OS 418 has been subject to an exploit or other softmod attack. In the illustrated embodiment, the determination of whether a SLIC table emerges during the boot process is checked for each instruction, as depicted by the decision block 508. Alternatively, such a check could be made after a plurality of instructions are simulated, at the end of the boot process, etc. In this example, if a SLIC table materializes in response to the simulated instruction, the system is marked as non-genuine as shown at block 510, and the process may be terminated at block 512.

If the SLIC table did not emerge as a result of simulating the current instruction, a check to determine the state of the boot process may be performed. In the example of FIG. 5, such a determination is made at block 514 where it is determined whether some predetermined point during or following the boot process has been reached, such as whether the hardware abstraction layer (HAL) has been loaded. It should be recognized that the determination of whether the HAL has been loaded at block 514 is depicted for purposes of example only, as any desired time or event relative to the boot process may be selected as the reference point. If the HAL has not been loaded (or other termination time/event has not yet occurred), the simulation continues. In this case, another instruction is fetched at block 502, and the process continues until all instructions are considered before loading of the HAL occurs, or until the system is deemed non-genuine. Thus, if no SLIC table is present at block 508 after all relevant instructions have been checked, and the HAL has been loaded (or other designated boot point has occurred), the process can terminate at block 512 with the knowledge that the OS was not subject to an exploit.

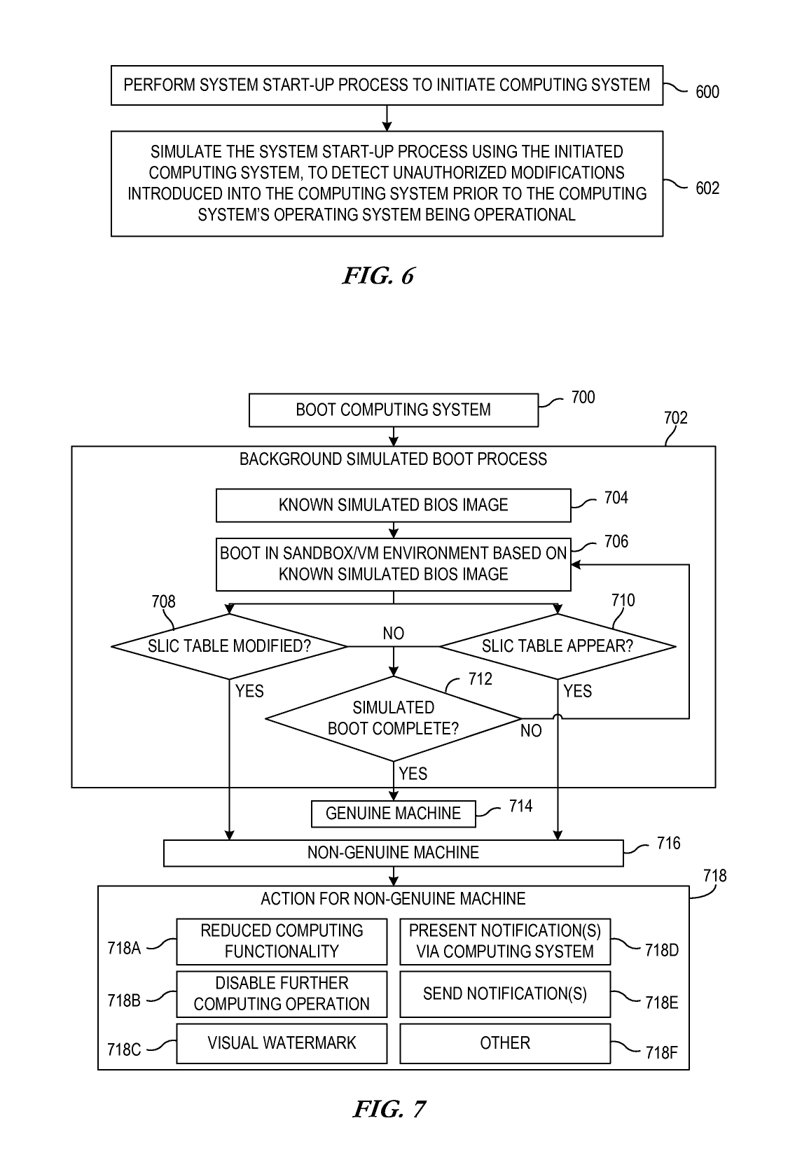

As previously noted, the techniques described herein may be used to detect, and in some cases take action against, the unauthorized introduction of code and/or data during a computing system start-up phase prior to operation of the OS. The embodiment described in connection with FIGS. 4 and 5 relates to a representative embodiment where activation exploits to evade OS licensing requirements may be detected. However, rather than looking for the materialization or modification of licensing information for such purposes, other firmware, software, data, etc. may be analyzed during a simulated boot process to identify other illicit activity introduced into the boot process. FIG. 6 is a flow diagram illustrating a technique for generally detecting the introduction of unauthorized code and/or data into a boot sequence before an operating system is operational.

At block 600 of FIG. 6, a system start-up (e.g. boot) process to initiate a computing system is performed. Thus, in one embodiment, block 600 represents the normal boot up process that occurs upon powering up or resetting a computing system. At block 602, the system start-up process is simulated using the initiated computing system. The simulation is configured to detect unauthorized modifications introduced into the computing system prior to the computing system's operating system being operational.

In one alternative embodiment, simulating the boot up process to detect unauthorized modifications involves simulating the system boot process in a sandbox environment that is isolated from normal operations of the computing system. In another embodiment, the sandbox environment involves a background process that is isolated from normal operations of the computing system. In yet another embodiment, the sandbox environment may be implemented using a virtual machine, which generally relates to an isolated guest operating system implemented via software emulation, hardware virtualization, etc. In still other embodiments, external processors and or other computing components may be used to carry out the simulation, although the code and data being analyzed from the original host system is used in the simulation.

As previously noted, one unauthorized activity that can be detected is an activation exploit that attempts to circumvent licensing requirements, such as to attempt to make a non-OEM machine appear to have a properly activated/licensed operating system for an OEM machine. FIG. 7 is a flow diagram illustrating an exemplary manner for detecting and acting on such activation exploits.

As depicted at block 700, a computing system is booted or otherwise initialized. In accordance with one embodiment, a background simulated boot process is executed as depicted at block 702. Functions associated with such a simulated boot process may include, for example, generating or otherwise providing a known simulated BIOS image as depicted at block 704. Another representative function of block 702 may be to run the background simulated boot process in a sandbox or virtual machine environment based on the known simulated BIOS image as shown at block 706. In one embodiment, simulating the boot process involves detecting unauthorized modifications by tracking changes occurring as a result of the simulated boot process, and identifying deviations of the tracked changes to a predetermined rule(s). In the illustrated embodiment, activation exploits are being monitored, and therefore the SLIC table or other licensing information is tracked to detect the unauthorized modifications. This determination is depicted at decision block 708, where it is determined whether the SLIC table has been modified. If a resulting SLIC table differs from its expected state, it is determined that tampering has occurred, and it is a non-genuine machine as shown at block 716.

In an alternate embodiment, simulating the boot process involves detecting the unauthorized modifications by comparing an outcome of the simulated boot process with an expected outcome based on known inputs to the boot process. For example, an expected outcome may be that no SLIC table is present after the boot process. In such a case, if a SLIC table appears as determined at block 710, it is determined that tampering has occurred, and it is a non-genuine machine as shown at block 716.

If the simulated boot process is not complete after any determinations made at blocks 708, 710, the booting process based on the known simulated BIOS image at block 706 continues. If the simulated boot process completes as determined at block 712 before any SLIC table modifications/materializations have occurred, the operating system can be deemed valid and the machine is a genuine machine as depicted at block 714.

If the machine is a non-genuine machine as shown at block 716, one embodiment involves taking action as depicted at block 718. Block 718 depicts various examples of actions that may be taken when an activation exploit has been detected. For example, blocks 718A and 718B respectively show representative actions of reducing or disabling the computing functionality. Another representative action may be to present a visual watermark as shown at block 718C, and/or present visual or audio notifications via the computing system as shown at block 718D. Notifications may be sent to an authority, the user, and/or other destinations as depicted at block 718E. Other actions depicted by block 718F may instead or additionally be utilized.

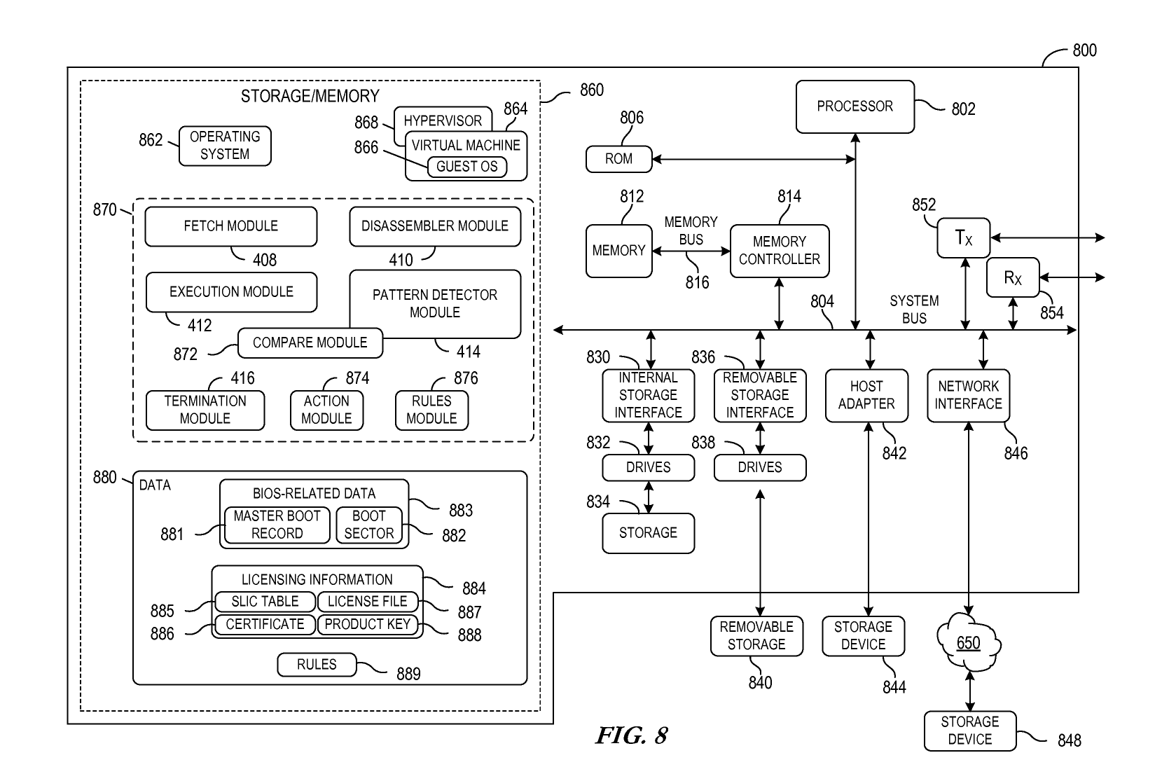

FIG. 8 depicts a representative computing apparatus or device 800 in which the principles described herein may be implemented. The representative computing device 800 can represent any one or more computing devices in which activation exploits, viruses, rootkits and/or other unauthorized pre-OS actions may be detected. For example, the computing device 800 may represent a server, desktop computer, laptop or other portable computing device, mobile phone, smart phone, personal digital assistant, other mobile computing/communication device, or any other device capable of performing computing functions. The computing environment described in connection with FIG. 8 is described for purposes of example, as the structural and operational disclosure for detecting unauthorized activity using a simulated boot process as described herein is applicable in any computing environment involving a boot process. It should also be noted that the computing arrangement of FIG. 8 may, in some embodiments, be distributed across multiple devices.

The representative computing device 800 may include a processor 802 coupled to numerous modules via a system bus 804. The depicted system bus 804 represents any type of bus structure(s) that may be directly or indirectly coupled to the various components and modules of the computing environment. A read only memory (ROM) 806 may be provided to store firmware used by the processor 802, such as the BIOS or equivalent initialization code. In one embodiment, the ROM 806 represents any type of read-only memory, such as programmable ROM (PROM), erasable PROM (EPROM), or the like.

The host or system bus 804 may be coupled to a memory controller 814, which in turn is coupled to the memory 812 via a memory bus 816. The techniques and embodiments described herein may be implemented in software that is stored in any storage, including volatile storage such as memory 812 and/or non-volatile storage devices. FIG. 8 illustrates various other representative storage devices in which applications, modules, data and other information may be temporarily or permanently stored. For example, the system bus 804 may be coupled to an internal storage interface 830, which can be coupled to a drive(s) 832 such as a hard drive. Storage 834 is associated with or otherwise operable with the drives. Examples of such storage include hard disks and other magnetic or optical media, flash memory and other solid-state devices, etc. The internal storage interface 830 may utilize any type of volatile or non-volatile storage.

Similarly, an interface 836 for removable media may also be coupled to the bus 804. Drives 838 may be coupled to the removable storage interface 836 to accept and act on removable storage 840 such as, for example, floppy disks, compact-disk read-only memories (CD-ROMs), digital versatile discs (DVDs) and other optical disks or storage, subscriber identity modules (SIMs), wireless identification modules (WIMs), memory cards, flash memory, external hard disks, etc. In some cases, a host adaptor 842 may be provided to access external storage 844. For example, the host adaptor 842 may interface with external storage devices via small computer system interface (SCSI), Fibre Channel, serial advanced technology attachment (SATA) or eSATA, and/or other analogous interfaces capable of connecting to external storage 844. By way of a network interface 846, still other remote storage may be accessible to the computing device 800. For example, wired and wireless transceivers associated with the network interface 846 enable communications with storage devices 848 through one or more networks 850. Storage devices 848 may represent discrete storage devices, or storage associated with another computing system, server, etc (e.g. store 208 of FIG. 2). Communications with remote storage devices and systems may be accomplished via wired local area networks (LANs), wireless LANs, and/or larger networks including global area networks (GANs) such as the Internet.

The computing device 800 may transmit and/or receive information from external sources, such as to send notifications, receive code or data, etc. Communications between the device 800 and other devices can be accomplished by way of direct wiring, peer-to-peer networks, local infrastructure-based networks (e.g., wired and/or wireless local area networks), off-site networks such as metropolitan area networks and other wide area networks, global area networks, etc. A transmitter 852 and receiver 854 are shown in FIG. 8 to depict a representative computing device's structural ability to transmit and/or receive code, data or other information in any of these or other communication methodologies. The transmitter 852 and/or receiver 854 devices may be stand-alone components, may be integrated as a transceiver(s), may be integrated into a different communication devices such as the network interface 846, etc.

The memory 812 and/or storage 834, 840, 844, 848 may be used to store programs and data used in connection with the various techniques for simulating a boot process to identify illicit or other unauthorized activity as described herein. The storage/memory 860 represents what may be stored in any one or more of the memory 812, storage 834, 840, 844, 848, and/or other data retention devices. In one embodiment, the representative device's 800 storage/memory 860 may include an operating system 862, and numerous operational modules executable by the processor 802 for carrying out technical operations described herein. As previously noted, the simulated boot processes described herein may be implemented as a background process, performed via a virtual machine or another sandbox environment. In one embodiment, a virtual machine 864 or other virtual operating platform is used to execute the boot process simulation, which may include a guest operating system 866 that may execute under the control of a hypervisor 868 or other virtual machine manager.

The operational modules may be executed as part of one or more applications operating on top of the OS 862 or guest OS 866, or one or more modules may be implemented elsewhere such as part of the OS 862 or guest OS 866 itself. Exemplary modules are described below.

A boot simulation module 870 is provided, which includes one or more modules to facilitate detection of unauthorized activity occurring prior to the OS 862 becoming operational during the boot process. Some representative modules that may be included as part of the boot simulation module 870 include the fetch module 408, disassembler module 410, execution module 412, pattern detector module 414 and termination module 416 as previously described in FIG. 4, where like reference numbers have been used. These representative modules were described in connection with FIG. 4. In one embodiment, the pattern detector module 414 is embodied by, or otherwise includes, a compare module 872 that may be used to compare actual simulation results to expected results to determine whether code or data is illicitly being injected into the boot process. An action module 874 may be provided to facilitate actions taken in response to recognizing the existence of unauthorized code or data. Block 718 of FIG. 7 provided various representative examples of the types of actions that may be taken by the action module 874. A rules module 876 may be provided for code that may be used to provide rules in which the pattern detector module 414, compare module 872 and/or other relevant module may employ to detect the unauthorized activity being monitored.

The storage/memory 860 also includes data 880, such as the master boot record 881, boot sector data 882 and/or other BIOS-related data 883. Licensing information 884 may also be stored as part of the stored data 880, such as the SLIC table 885 data previously described. Other licensing-related data may include, for example, a digital certificate(s) 886, license file(s) 887, product key(s) 888, etc. Data 880 may also include rules data 889, which may be used by, for example, any one or more of the pattern detector module 414, compare module 872, rules module 876 to detect the unauthorized activity being monitored.

As previously noted, the representative computing device 800 in FIG. 8 is provided for purposes of example, as any computing device having processing capabilities can carry out the functions described herein using the teachings described herein. Any one or more of these modules may be implemented in programs, applications, operating systems, etc. These modules and data are depicted for purposes of illustration, and do not represent an exhaustive list. Any programs or data described or utilized in connection with the description provided herein may be associated with the storage/memory 860.

As demonstrated in the foregoing examples, embodiments described herein facilitate identification of activation exploits, viruses, rootkits, and other malware impacting a system before an operating system is operational, using a simulated boot process. In various embodiments, methods are described that can be executed on a computing device(s), such as by providing software modules that are executable via a processor (which includes a physical processor and/or logical processor, controller, etc.). The methods may also be stored on computer-readable media that can be accessed and read by the processor and/or circuitry that prepares the information for processing via the processor. For example, the computer-readable media may include any digital storage technology, including memory 812, storage 834, 840, 844, 848, any other volatile or non-volatile storage, etc.

Any resulting program(s) implementing features described herein may include computer-readable program code embodied within one or more computer-usable media, thereby resulting in computer-readable media enabling storage of executable functions described herein to be performed. As such, terms such as “computer-readable medium,” “computer program product,” computer-readable storage, computer-readable media or analogous terminology as used herein are intended to encompass a computer program(s) existent temporarily or permanently on any computer-usable medium.

Having instructions stored on computer-readable media as described herein is distinguishable from instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A computer-implemented method comprising:
performing a system start-up process to initiate a computing system; and
simulating the system start-up process using the initiated computing system to detect unauthorized modifications introduced into the computing system prior to the computing system's operating system being operational.

2. The computer-implemented method of claim 1, wherein simulating the system start-up process to detect unauthorized modifications comprises simulating the system start-up process in a sandbox environment isolated from normal operations of the computing system.

3. The computer-implemented method of claim 2, wherein the sandbox environment comprises a background process isolated from the normal operations of the computing system.

4. The computer-implemented method of claim 1, wherein simulating the system start-up process comprises detecting the unauthorized modifications by tracking changes occurring as a result of the simulated start-up process, and identifying deviations of the tracked changes to at least one predetermined rule.

5. The computer-implemented method of claim 1, wherein simulating the system start-up process comprises detecting the unauthorized modifications by comparing an outcome of the simulated start-up process with an expected outcome based on known inputs to the simulated start-up process.

6. The computer-implemented method of claim 1, wherein simulating the system start-up process comprises:
initiating the simulating of the system start-up process with no original equipment manufacturer (OEM) licensing information for the computing system's operating system;
monitoring for materialization of OEM licensing information during the simulation of the system start-up process; and
designating the computing system's operating system as unauthorized if the OEM licensing information materializes during the simulation of the system start-up process.

7. The computer-implemented method of claim 1, wherein simulating the system start-up process comprises:
tracking a state of a licensing signature for the computer system's operating system in a BIOS component during the simulation of the system start-up process;
comparing the tracked state of the licensing signature to an expected licensing signature; and
determining that the licensing signature has been tampered with if the tracked state of the licensing signature differs from the expected licensing signature.

8. The computer-implemented method of claim 1, further comprising at least reducing functionality of the operating system as a result of detecting that unauthorized modifications were introduced into the computing system during the simulating of the system start-up process.

9. The computer-implemented method of claim 1, further comprising taking at least one action in response to detecting that unauthorized modifications were introduced into the computing system during the simulating of the system start-up process.

10. An apparatus comprising:
storage to store instructions used to initialize a computing system and its operating system;
a simulated boot engine configured to detect activation exploits introduced on the computing system prior to the operating system being loaded, comprising:
an execution module configured to simulate execution of the stored instructions; and
a pattern detector module configured to compare licensing information resulting from the simulated execution of the stored instructions to expected licensing information based on one or more rules, and to detect the activation exploits based on a mismatch of the comparison.

11. The apparatus of claim 10, further comprising a module configured to impact operability of the operating system if the activation exploit is detected.

12. The apparatus of claim 10, wherein:
the licensing information includes a SLIC table;
the rules include identifying materialization of a SLIC table during the simulated execution of the stored instructions; and
the pattern detector module is configured to compare licensing information by determining whether the SLIC table materializes during the simulated execution of the stored instructions, and to detect the activation exploits if the SLIC table materialized during the simulated execution of the stored instructions.

13. The apparatus of claim 10, wherein:
the licensing information includes a SLIC table;
the rules include identifying changes to a SLIC table during the simulated execution of the stored instructions; and
the pattern detector module is configured to compare licensing information by determining whether unexpected changes to the SLIC table occur during the simulated execution of the stored instructions, and to detect the activation exploits if the unexpected changes to the SLIC table occurred during the simulated execution of the stored instructions.

14. The apparatus of claim 10, further comprising a sandbox operating environment isolated from a primary operating environment of the computing system, wherein the simulated boot engine is implemented in the sandbox operating environment.

15. The apparatus of claim 10, further comprising a virtual machine in which the simulated boot engine is implemented.

16. The apparatus of claim 10, wherein the simulated boot engine comprises software executable by a processor to provide at least the execution module and the pattern detector module.

17. Computer-readable media having instructions stored thereon which are executable by a processor for performing functions comprising:
booting a computing system having an operating system;
after the operating system is operational, simulating the booting of the computing system in a sandbox environment isolated from normal operations of the computing system, wherein simulating the booting of the computing system comprises:
reading instructions from one or more boot sectors of boot media;
executing the instructions;
monitoring a software licensing description (SLIC) table for illicitly-introduced code or data; and
if the monitoring of the SLIC table identifies the presence of the illicitly-introduced data, designating the operating system as an unauthorized operating system.

18. The computer-readable media as in claim 17, wherein the instructions for monitoring a SLIC table for illicitly-introduced code or data comprise instructions for monitoring for the materialization of the SLIC table in view of the simulating of the booting being configured to include no SLIC table.

19. The computer-readable media as in claim 17, wherein the instructions for monitoring a SLIC table for illicitly-introduced code or data comprise instructions for monitoring for an unexpected change of the SLIC table as a result of the simulating of the booting.

20. The computer-readable media as in claim 17, further comprising instructions executable by the computing system for at least reducing a functionality of the operating system in response to designating the operating system as an unauthorized operating system.
